(19) United States
(12) Patent Application Publication
(10) Pub. No.: US 2022/0281457 A1
(43) Pub. Date: Sep. 8, 2022

(54) DRIVING FORCE CONTROL SYSTEM FOR VEHICLE

(71) Applicant: TOYOTA JIDOSHA KABUSHIKI KAISHA, Toyota-shi Aichi-ken (JP)

(72) Inventors: Kunihiko Usui, Fuji-shi Shizuoka-ken (JP); Keisuke Ushida, Sunto-gun Shizuoka-ken (JP)

(21) Appl. No.: 17/683,868

(22) Filed: Mar. 1, 2022

(30) Foreign Application Priority Data
Mar. 5, 2021 (JP) 2021-035690

(51) Int. Cl. B60W 30/18; B60W 50/14

(52) U.S. Cl. CPC B60W 30/18172; B60W 50/14; B60W 2552/15; B60W 2530/16; B60W 2552/40; B60W 2540/10; B60W 2520/10; B60W 2720/10

(57) ABSTRACT

A driving force control system that allows a vehicle to climb uphill without stopping. A controller is configured to: calculate a slip ratio of a road surface, a driving force with respect to the slip ratio, and a running resistance including a grade resistance of the road surface, before the vehicle reaches a starting point of an upcoming uphill, determine whether the vehicle can climb the uphill all the way to the top based on the driving force and the running resistance, and execute a driver assisting control to instruct a driver to manipulate an accelerator in such a manner as to optimize the slip ratio to establish a predetermined driving force, if the vehicle can climb uphill all the way to the top.

### CROSS REFERENCE TO RELATED APPLICATIONS

The present disclosure claims the benefit of Japanese Patent Application No. 2021-035690 filed on Mar. 5, 2021 with the Japanese Patent Office.

### BACKGROUND

### Field of the Disclosure

Embodiments of the present disclosure relate to the art of a control system for vehicles configured to control a driving force to propel the vehicle in accordance with a road surface condition such as a road grade.

### Discussion of the Related Art

JP-A-2017-077765 describes a vehicular control device that determines whether a vehicle can climb a gradient road surface or not before the vehicle cannot climb the gradient road surface. Specifically, the control device described in JP-A-2017-077765 is configured to calculate a drivable road grade based on an engine torque, an intake-air temperature, a gear ratio, and a load weight, and to determine whether the vehicle can climb a surface. According to the teachings of JP-A-2017-077765, the control system notifies a driver of a determination result.

If a road grade is too steep, the vehicle would not be able to climb uphill. As described, the control device taught by JP-A-2017-077765, calculates the drivable road grade based on the above-mentioned variable parameters including an engine torque, a gear ratio and so on. If the calculated drivable road grade is less than an actual grade of a graded surface, the control device taught by JP-A-2017-077765 determines that the vehicle cannot climb the gradient surface. However, when climbing uphill, a vehicle speed will not drop immediately to zero. That is, if a vehicle speed is high enough when starts climbing uphill, the vehicle would be able to climb uphill all the way to the top while decelerating. Likewise, if an acceleration greater than a running resistance including a road grade, an air resistance, and a rolling resistance is available, the vehicle would be able to climb uphill all the way to the top. That is, the vehicle is allowed to climb uphill without stopping by controlling a driving force in such a manner as to establish a required vehicle speed and an acceleration to climb the graded surface.

### SUMMARY

Aspects of the present disclosure have been conceived noting the foregoing technical problems, and it is therefore an object of the present disclosure to provide a driving force control system that allows a vehicle to climb uphill without stopping.

According to one aspect of the present disclosure, there is provided a driving force control system that detects a road surface condition to control a driving force to allow the vehicle to climb uphill. In order to achieve the above-explained objective, the control system is provided with a controller that controls the driving force. According to one aspect of the present disclosure the controller is configured to: calculate a slip ratio of a road surface on which the vehicle travels, a driving force with respect to the slip ratio, and a running resistance including a grade resistance of the road surface, before the vehicle reaches a starting point of an upcoming uphill; determine whether the vehicle can climb the uphill all the way to the top based on the driving force and the running resistance; and execute a driver assisting control to instruct a driver to manipulate an accelerator in such a manner as to optimize the slip ratio to establish a predetermined driving force, if the vehicle can climb uphill all the way to the top.

In a non-limiting embodiment, the controller may be further configured to: calculate a required speed of the vehicle to climb the uphill all the way to the top from the starting point of the uphill, if the vehicle cannot climb the uphill all the way to the top; determine whether speed of the vehicle at the starting point of the uphill is higher than the required speed; and execute the driver assisting control to instruct the driver to manipulate the accelerator in such a manner as to optimize the slip ratio to establish the predetermined driving force, if the speed of the vehicle at the starting point of the uphill is higher than the required speed.

According to another aspect of the present disclosure, there is provided a driving force control system for a vehicle that detects a road surface condition including a slip ratio to control a driving force to allow the vehicle to climb an uphill. In order to achieve the above-explained objective, the control system is provided with a controller that controls the driving force. According to another aspect of the present disclosure the controller is configured to: calculate a required speed of the vehicle to climb the uphill all the way to the top from a starting point of the uphill; determine whether a speed of the vehicle at the starting point of the uphill is higher than the required speed; and execute a driver assisting control to instruct a driver to manipulate an accelerator in such a manner as to optimize the slip ratio to establish a predetermined driving force, if the speed of the vehicle at the starting point of the uphill is higher than the required speed.

In a non-limiting embodiment, the controller may be further configured to: determine whether the vehicle can be accelerated to increase the speed of the vehicle to the required speed or higher at the starting point of the uphill, if the speed of the vehicle at the starting point of the uphill is lower than the required speed; and execute the driver assisting control to instruct the driver to manipulate the accelerator in such a manner as to optimize the slip ratio to establish the predetermined driving force, if the vehicle can be accelerated to increase the speed of the vehicle to the required speed or higher at the starting point of the uphill.

In a non-limiting embodiment, the controller may be further configured to set the required speed to a value at which a kinetic energy of the vehicle comes into balance with a potential energy of the vehicle at the top of the uphill.

In a non-limiting embodiment, the controller may be further configured to determine whether the vehicle can be accelerated to increase the speed of the vehicle to the required speed based on a current speed of the vehicle, the required speed, an acceleration of the vehicle, a required period of time to increase the speed of the vehicle from the current speed to the required speed, and a distance from a current location of the vehicle to the starting point of the uphill.

In a non-limiting embodiment, the controller may be further configured to: calculate a restarting point where it is possible to ensure a distance necessary to increase the speed of the vehicle to the required speed before the vehicle reaches the starting point of the uphill, if the vehicle cannot be accelerated to increase the speed of the vehicle to the required speed; and instruct the driver to return the vehicle to the restarting point.

In a non-limiting embodiment, an operating mode of the vehicle may include an autonomous mode in which the driving force is controlled autonomously by the controller without requiring a manual operation.

In a non-limiting embodiment, the accelerator may include an accelerator pedal, and the controller is further configured to instruct the driver to depress and return the accelerator pedal.

Thus, the control system according to the exemplary embodiment of the present disclosure is configured to determine whether the vehicle can climb uphill all the way to the top. If the vehicle cannot climb uphill all the way to the top, the control system executes the driver assisting control to instruct driver to manipulate the accelerator pedal in such a manner as to optimize the slip ratio so as to climb uphill all the way to the top. In a case that the vehicle cannot climb uphill all the way to the top at the current vehicle speed, the required vehicle speed possible to reach the top of the hill is calculated. In this case, if the vehicle speed at the starting point of the uphill is equal to or higher than the required speed, the driver is instructed how to manipulate the accelerator pedal to climb uphill all the way to the top.

If the current vehicle speed is lower than the required vehicle speed, the driver is instructed to operate the accelerator pedal in such a manner as to increase the speed of the vehicle from the current speed to the required speed. Further, if the speed of the vehicle cannot be increased to the required vehicle speed within the required period of time, the driver is instructed to return the vehicle to the restarting point where it is possible to ensure a distance necessary to increase the speed of the vehicle to the required vehicle speed before the vehicle reaches the starting point of the uphill.

According to the exemplary embodiment of the present disclosure, therefore, the vehicle is allowed to reach the top of the uphill in every situation without stopping on the way to the top.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of a vehicle to which the control system according to the embodiment of the present disclosure is applied;

FIG. 2 is a flowchart showing one example of a routine executed by the control system according to the exemplary embodiment of the present disclosure;

FIG. 3 is a map determining a relation among a slip ratio, a driving force, and an acceleration;

FIG. 4 is a schematic illustration showing one example of an indicator indicating an instruction during execution of the driver assisting control; and

FIG. 5 is a schematic illustration showing one example of a restarting point to climb uphill.

### DETAILED DESCRIPTION

Embodiments of the present disclosure will now be explained with reference to the accompanying drawings. Note that the embodiments shown below are merely examples of the present disclosure, and do not limit the present disclosure.

The driving force control system according to the embodiment of the present disclosure is applied to vehicles having at least one of a motor and an engine serving as a prime mover. For example, the driving force control system according to the embodiment of the present disclosure may be applied to an electric vehicle in which only a motor serves as the prime mover, and a hybrid vehicle in which a prime mover includes an engine and a motor. The electric vehicle includes a battery electric vehicle in which only a motor is employed as a prime mover, and a range extender electric vehicle in which an engine is operated only to generate electricity. In addition, the driving force control system may also be applied to a plug-in electric vehicle, a plug-in hybrid vehicle, and a fuel-cell vehicle.

A vehicle Ve to which the control system according to the exemplary embodiment of the present disclosure is applied may be operated autonomously. Specifically, the control system is configured to execute a starting operation, an accelerating operation, a steering operation, a braking operation, a stopping operation etc. of the vehicle Ve autonomously, while recognizing and observing an external condition and a travelling condition. As explained later, an operating mode of the vehicle Ve may be selected by a mode selector switch SW between an autonomous mode and a manual mode.

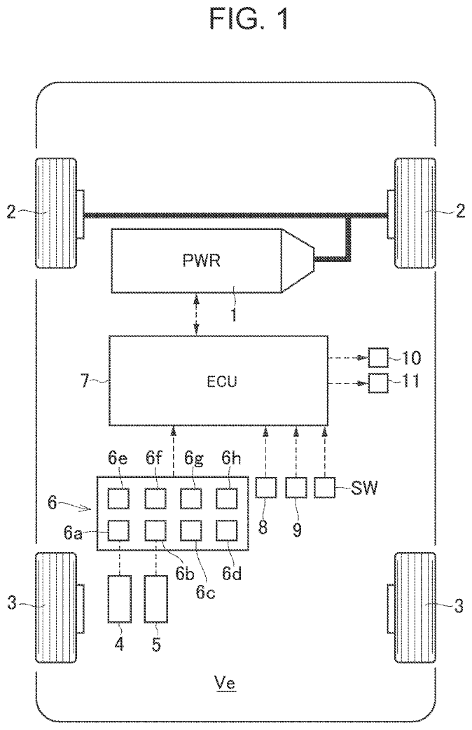

Referring now to FIG. 1, there is shown an example of a drive system of the vehicle Ve to which the driving force control system according to the exemplary embodiment of the present disclosure is applied. The vehicle Ve comprises a prime mover (referred to as “PWR” in FIG. 1) 1, a pair of front wheels 2, a pair of rear wheels 3, an accelerator pedal 4, a brake pedal 5, a detector 6, and an electronic control unit (to be abbreviated as the “ECU” hereinafter) 7 as a controller.

The prime mover 1 generates a drive torque to establish a driving force to propel the vehicle Ve. For example, an internal combustion engine such as a gasoline engine and a diesel engine may be adopted as the prime mover 1. An output power of the engine may be adjusted electrically, and the engine may be started and stopped electrically according to need. Given that the gasoline engine is adopted as the prime mover 1, an opening degree of a throttle valve, an amount of fuel supply or fuel injection, a commencement and a termination of ignition, an ignition timing etc. may be controlled electrically. Otherwise, given that the diesel engine is adopted as the prime mover 1, an amount of fuel injection, an injection timing, an opening degree of a throttle valve of an EGR (Exhaust Gas Recirculation) system etc. may be controlled electrically.

Further, a permanent magnet type synchronous motor and an induction motor may also be adopted as the prime mover 1. Those kinds of motors may serve not only as a motor to generate torque when driven by electricity suppled thereto, but also as a generator to generate electricity when rotated by a torque applied thereto. That is, a motor-generator may also be adopted as the prime mover 1. In this case, the motor serving as prime mover 1 is electrically connected with a battery through an inverter (neither of which are shown) so that the motor is switched between a motor and a generator by electrically controlling the prime mover 1. Specifically, the motor is operated as a motor by supplying electricity thereto from the battery, and electricity generated by the motor serving as a generator may be accumulated in the battery.

In the vehicle Ve shown in FIG. 1, the front wheels 2 serve as drive wheels, and a drive torque generated by the prime mover 1 is delivered to the front wheels 2 to establish a driving force. However, the driving force control system according to the embodiment of the present disclosure may also be applied to a rear-drive layout vehicle in which the rear wheels 3 serve as drive wheels, and a four-wheel drive vehicle in which all of the wheels 2 and 3 are driven by the torque of the prime mover 1. As an option, a transmission (not shown) may be arranged downstream of the prime mover 1 to deliver the output torque of the prime mover 1 to the drive wheels via the transmission.

The driving force to propel or accelerate the vehicle Ve is changed in accordance with a position of the accelerator pedal 4 that is manipulated by a driver. Specifically, the drive torque of the prime mover 1 is increased in accordance with an increase in depression (or an operating amount) of the accelerator pedal 4 thereby increasing the driving force to propel the vehicle Ve. By contrast, the drive torque of the prime mover 1 is reduced by returning the accelerator pedal 4. In other words, the drive torque of the prime mover 1 is reduced with a reduction in depression of the accelerator pedal 4 thereby reducing the driving force to propel the vehicle Ve. Given that the motor is adopted as the prime mover 1, a regenerative braking force derived from a regenerative torque of the motor is applied to the vehicle Ve when the accelerator pedal 4 is returned. By contrast, given that the engine is adopted as the prime mover 1, an engine braking force derived from a friction torque and a pumping loss is applied to the vehicle Ve when the accelerator pedal 4 is returned.

The braking force applied to the vehicle Ve is changed by manipulating the brake pedal 5. For example, a hydraulic disc brake and a drum brake may be adopted as a brake device, and the brake device is actuated to establish a brake force by depressing the brake pedal 5. Given that a one-pedal mode is available in the vehicle Ve, the vehicle Ve may be accelerated and decelerated only by manipulating the accelerator pedal 4 in accordance with a position of the accelerator pedal 4. In this case, the brake device may be controlled in conjunction with an operation of the accelerator pedal 4.

In order to collect data necessary to control the vehicle Ve, the detector 6 is provided with a power source, a microcomputer, sensors, an input-output interface and so on. Specifically, the detector 6 comprises: an accelerator position sensor 6a that detects an operating amount (or a position) of the accelerator pedal 4; a brake stroke sensor 6b that detects an operating amount (i.e., stroke or depression) of the brake pedal 5; a vehicle speed sensor 6c that detects a speed of the vehicle Ve; a wheel speed sensor 6d that detects speed of the wheels 2 and 3; an acceleration sensor 6e that detects an acceleration of the vehicle Ve; a weight sensor 6f that detects a weight of the vehicle Ve including a load on the vehicle Ve; an on-board camera 6g that records the view around the vehicle Ve; a GPS (i.e., global positioning system) receiver 6h that obtains a position (i.e., latitude and longitude) of the vehicle Ve based on incident signals from GPS satellites. The detector 6 is electrically connected to the ECU 7 so that data collected by those sensors and devices are transmitted to the ECU 7 in the form of electric signal.

The ECU 7 also receives signals transmitted from a digital map database 8, a navigation system 9, and the mode selector switch SW. The map database 8 may be installed in the ECU 7, but a map information stored in an external online information processing center may be available as the map database 8. The navigation system 9 is configured to determine a travelling route of the vehicle Ve based on the positional information obtained by the GPS receiver 6h and the map database 8. Specifically, the mode selector switch SW includes a switch for selecting an operating mode of the vehicle Ve between a manual mode and an autonomous mode, and a switch for selecting a road surface condition from e.g., a paved road, a sandy road, a muddy road, and a snow-covered road. The ECU 7 controls the driving force to propel the vehicle Ve in accordance with a road condition selected by the mode selector switch SW.

The ECU 7 comprises a microcomputer as its main constituent. As described, the data collected by the detector 6 is sent to the ECU 7 to control the vehicle Ve, and the ECU 7 performs calculation using the incident data transmitted from the detector 6 as well as data and formulas stored in advance. Calculation results are transmitted from the ECU 7 in the form of command signal. The ECU 7 may exchange data with external servers and terminals (neither of which are shown) so as to control the vehicle Ve in conjunction with the external servers and the terminals. To this end, the ECU 7 transmits the data collected by the detector 6 to e.g., a predetermined external server, and receives data analyzed by the external server based on the data transmitted to the external server. In this case, therefore, the vehicle Ve is controlled by the ECU 7 based on the data analyzed by the external server.

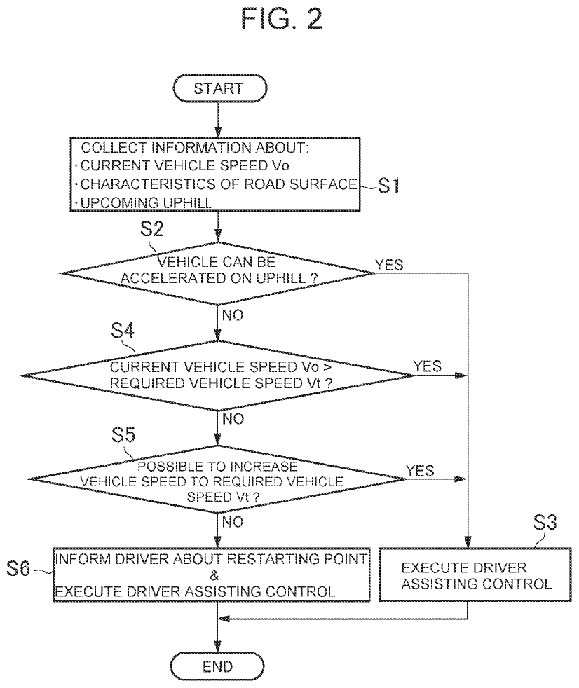

If a road grade is too steep and a running resistance on the road surface exceeds the maximum driving force to propel the vehicle Ve, the vehicle Ve would not be able to climb uphill all the way to the top. In order to allow the vehicle Ve to travel uphill without stopping, according to the exemplary embodiment of the present disclosure, the ECU 7 is configured to execute the routine shown in FIG. 2 while the vehicle Ve is traveling on a flat road before climbing uphill.

In order to calculate an acceleration and a vehicle speed required to climb uphill all the way to the top, at step S1, the detector 6 collects information relating to a current speed of the vehicle Ve, characteristics of a road surface on which the vehicle Ve is currently travelling, and characteristics of an upcoming uphill.

Specifically, the characteristics of the road surface is a relation among a slip ratio λ of the road surface, a driving force F, a running resistance R, and an accelerating force AF, and those parameters are calculated at step S1 based on the information collected by the detector 6.

The slip ratio λ of the road surface may be calculated by dividing a difference of a wheel speed Vw and a current vehicle speed Vo by the wheel speed Vw or the current vehicle speed Vo whichever is greater. For example, given that the current vehicle speed Vo is greater than the wheel speed Vw, the slip ratio λ may be expressed as:

λ=(V_{w}−V₀)/V₀ (1).

The driving force F may be calculated by converting a torque of the prime mover 1 into the driving force F. For example, the driving force F may be calculated by dividing a torque of a driveshaft by a radius of a tire. Otherwise, the driving force F may also be calculated by dividing a product of a required driving force and a gear ratio of a differential by a radius of a tire.

The running resistance R includes a grade resistance, a rolling resistance, and an air resistance, and the running resistance R may be calculated by subtracting a product of a weight M and an acceleration “a” of the vehicle Ve from the driving force F as expressed by the following expression:

R=F−M·α (2).

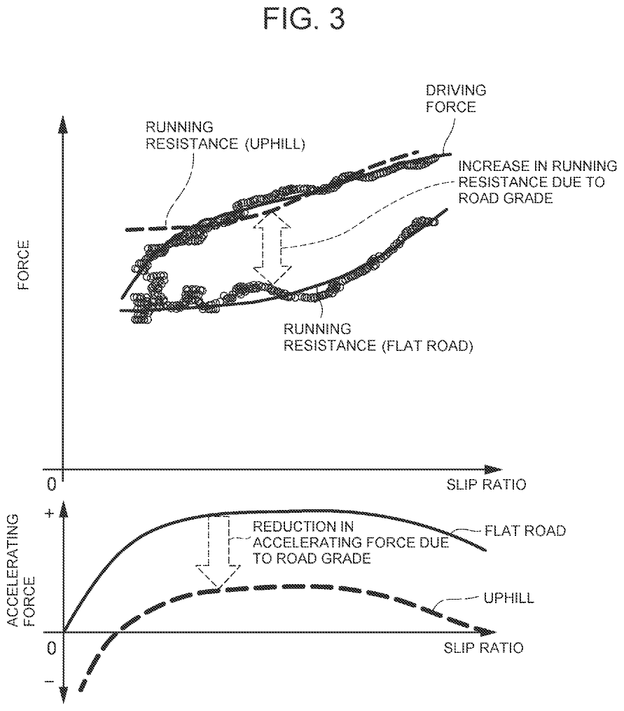

The accelerating force AF may be calculated based on a difference between the driving force F and the running resistance R. For example, the accelerating force AF may be obtained with reference to a map shown in FIG. 3 for determining the accelerating force AF required to travel on a surface on which the running resistance R is large such as a sandy road, a muddy road, and a snow-covered road. In FIG. 3, the solid curve indicates characteristics of a surface of a flat road, and the dashed curve indicates characteristics of a surface of an uphill. In this case, as indicated in FIG. 3, the driving force F and the running resistance R with respect to the slip ratio λ are approximated into quadratic curves by the method of least squares, and the accelerating force AF is determined based on a difference between the driving force F and the running resistance R.

The information relating to the upcoming uphill includes a distance L from a current location of the vehicle Ve to a starting point of the uphill, a distance L′ from the current location of the vehicle Ve to the top of the uphill, an altitude h of the top of the uphill, and a road grade θ of the uphill. Such information may be collected by the GPS receiver 6h and the map database 8.

Then, it is determined at step S2 whether the vehicle Ve can be accelerated on the uphill. That is, it is determined at step S2 whether the vehicle Ve can overcome the running resistance R to reach the top of the hill. At step S2, specifically, it is determined whether the accelerating force AF established by generating a maximum acceleration is a positive value which is greater than zero. In other words, it is determined whether the maximum driving force F is greater than the running resistance R including the grade resistance, the rolling resistance, and the air resistance. As described, the accelerating force AF corresponds to the difference between the driving force F and the running resistance R. As indicated by the dashed line in FIG. 3, the running resistance R is increased by the grade resistance in the case of travelling uphill, compared to the case of travelling on a flat road. In the case of travelling uphill, therefore, the accelerating force AF is reduced by such increase in the running resistance R compared to the case of travelling on a flat road. As can be seen from FIG. 3, the accelerating force AF turns into a negative value and the running resistance R is greater than the driving force F if the slip ratio λ is very low. By contrast, the accelerating force AF turns into a positive value if the slip ratio λ falls within a predetermined higher range. Specifically, the grade resistance may be expressed as MgsinO where M is a weight of the vehicle Ve, “g” is an acceleration of gravity, and “θ” is a road grade. The air resistance and the rolling resistance may be calculated by the conventional procedures.

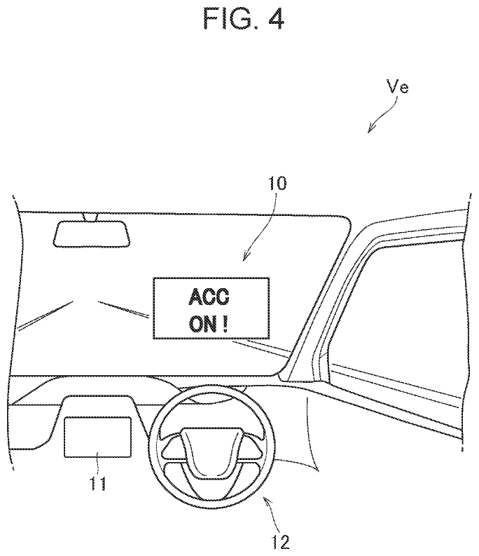

If the vehicle Ve can be accelerated on the hill to reach the top of the hill, that is, if the accelerating force AF is a positive value so that the answer of step S2 is YES, the routine progresses to step S3 to execute a driver assisting control. The driver assisting control includes a control to instruct the driver to operate the accelerator pedal 4, and an autonomous control of the driving force. As described, the operating mode of the vehicle Ve may be selected from the manual mode and the autonomous mode. As known in the conventional art, an optimum slip ratio to achieve a maximum grip of a tire on a road surface is approximately 20%. That is, if the driving force generated by the prime mover is insufficient, the slip ratio is reduced from the optimum ratio and hence a required accelerating force derived from the driving force may not be ensured. By contrast, if the driving force generated by the prime mover is excessive, the slip ratio is also reduced from the optimum ratio and hence the required accelerating force derived from the driving force may not be ensured. According to the exemplary embodiment of the present disclosure, therefore, a target slip ratio (i.e., an optimum slip ratio) governed by a design of the vehicle Ve is determined in advance. For example, if the manual mode is selected in this situation, the driver is instructed to operate the accelerator pedal 4 in such a manner as to achieve the target slip ratio required to establish the acceleration possible to climb uphill all the way to the top. In the example shown in FIG. 4, an instruction message to urge the driver to depress the accelerator pedal 4 is indicated in a headup display 10. As an option, a digital meter or the like may be indicated in the headup display 10 to indicate a degree of depression of the accelerator pedal 4 required to reach the top of the hill.

Such instruction message may also be indicated in a human-machine interface 11 that offers information to driver and that is operated by the driver. Otherwise, such instruction message may also be transmitted to the driver phonically by a voice message or acoustically by a sound or tone. Further, such instruction message may also be transmitted physically to the driver by vibrating a steering wheel 12 or a seat. In addition, in order to assist the driver to operate the accelerator pedal 4 more effectively, the target slip ratio to achieve a target driving force and the target acceleration, and a map shown in FIG. 3 may also be indicated in the human-machine interface 11. That is, a running condition of the vehicle Ve and a road surface condition may be visualized to instruct the driver to operate the accelerator pedal 4 more easily and properly.

Whereas, if the autonomous mode is selected in this situation, the driving force is controlled autonomously to accelerate the vehicle Ve without requiring the driver to operate the accelerator pedal 4. In this case, specifically, a required driving force and a required accelerating force to climb uphill all the way to the top are calculated, and the prime mover 1 is controlled to generate a torque to achieve the required driving force and the required accelerating force thereby accelerating the vehicle Ve.

By contrast, if the running resistance R is equal to or greater than the driving force F, that is, if the accelerating force AF is zero or less so that the answer of step S2 is NO, the routine progresses to step S4 to determine whether a current vehicle speed Vo at a starting point of the uphill is higher than a required vehicle speed Vt. In this case, although the vehicle Ve is decelerated by the grade resistance, the speed of the vehicle Ve will not be reduced immediately to zero. That is, it may be possible that the vehicle Ve reaches the top of the hill while decelerating. At step S4, therefore, it is determined whether the vehicle Ve can reach the top of the hill at the current vehicle speed Vo.

In order to make such determination, the required vehicle speed Vt is calculated based on a potential energy expressed as Mgh where “M” is the weight of the vehicle Ve, “g” is the acceleration of gravity, and “h” is the altitude of the top of the hill. Specifically, the required vehicle speed Vt is set to a value possible to satisfy the following expression:

½ MVt²=MGh (3).

That is, the required vehicle speed Vt is set to a value at which a kinetic energy of the vehicle Ve comes into balance with the potential energy. Specifically, the required vehicle speed Vt is set to a value at which a kinetic energy of the vehicle Ve can be maintained to an energy corresponding to a grade resistance of the uphill. For example, given that the vehicle speed at the starting point of the uphill is the required vehicle speed Vt, it is sufficient to generate a driving force possible to overcome a running resistance except for a grade resistance. In this situation, given that the road surface condition is constant except for a road grade and that the vehicle speed at the starting point of the uphill is the required vehicle speed Vt or higher, the vehicle Ve can climb the uphill all the way to the top by the current driving force.

If the current vehicle speed Vo is equal to or higher than the required vehicle speed Vt so that the answer of step S4 is YES, the routine also progresses to Step S3 to execute the driver assisting control. In this case, if the manual mode is selected, the driver is also instructed to operate the accelerator pedal 4 in such a manner as to achieve the target slip ratio required to establish the acceleration possible to climb uphill all the way to the top. As described, such instruction may be transmitted to the driver visually, phonically, acoustically or physically. Whereas, if the autonomous mode is selected in this situation, the driving force is controlled autonomously to achieve the target slip ratio.

By contrast, if the current vehicle speed Vo is slower than the required vehicle speed Vt so that the answer of step S4 is NO, the routine progresses to step S5 to determine whether the speed of the vehicle Ve can be increased from the current vehicle speed Vo to the required vehicle speed Vt before the vehicle Ve reaches the starting point of the uphill from the current location of the vehicle Ve.

At step S5, specifically, a required period of time t to increase the speed of the vehicle Ve from the current vehicle speed Vo to the required vehicle speed Vt is calculated using the following formula:

V₀+at=Vt (4);

where “a” is a maximum acceleration of the vehicle Ve governed by the maximum accelerating force AF which can be obtained with reference to the map shown in FIG. 3 and the weight M of the vehicle Ve. Then, it is determined whether a distance required to increase the speed of the vehicle Ve from the current vehicle speed Vo to the required vehicle speed Vt is equal to or shorter than the distance L from the current location of the vehicle Ve to the starting point of the uphill. Specifically, it is determined whether the following inequality is satisfied:

V₀t+½·at²≤L (5).

If the speed of the vehicle Ve can be increased to the required vehicle speed Vt before the vehicle Ve reaches the starting point of the uphill so that the answer of step S5 is YES, the routine also progresses to step S3 execute the driver assisting control. As described, if the manual mode is selected, the driver is also instructed to operate the accelerator pedal 4 in such a manner as to achieve the slip ratio λ required to establish the acceleration possible to climb uphill all the way to the top. In this situation, for example, the driver is instructed how to operate the accelerator pedal 4 to increase the speed of the vehicle Ve to the required vehicle speed Vt before the vehicle Ve reaches the starting point of the uphill. As described, such instruction may be transmitted to the driver visually, phonically, acoustically or physically. Whereas, if the autonomous mode is selected in this situation, the driving force is controlled autonomously to climb uphill all the way to the top.

By contrast, if the speed of the vehicle Ve cannot be increased to the required vehicle speed Vt before the vehicle Ve reaches the starting point of the uphill so that the answer of step S5 is NO, the routine progresses to step S6 to notify the driver of a fact that it is not possible to climb uphill all the way to the top. In this case, the distance L from the current location of the vehicle Ve to the starting point of the uphill is shorter than the distance required to increase the speed of the vehicle Ve from the current vehicle speed Vo to the required vehicle speed Vt. That is, it is necessary to return the vehicle Ve to a restarting point where it is possible to ensure a distance necessary to increase the speed of the vehicle Ve to the required vehicle speed Vt before the vehicle Ve reaches the starting point of the uphill. At step S6, therefore, the driver is instructed to return the vehicle Ve to the restarting point by e.g., the headup display 10, the human-machine interface 11 or the voice message. In addition, at step S6, the driver assisting control is also executed to instruct the driver to manipulate the accelerator pedal 4 in such a manner that it is possible to achieve the required vehicle speed Vt.

Here will be explained how to calculate the above-mentioned restarting point. First of all, a required period of time t′ to increase the speed of the vehicle Ve from zero to the required vehicle speed Vt is calculated using the following formula:

at=Vt′ (6).

Then, a distance X from the starting point of the uphill to the restarting point is calculated by substituting the calculated required period of time t′ into the following equation:

½·at′²=X (7).

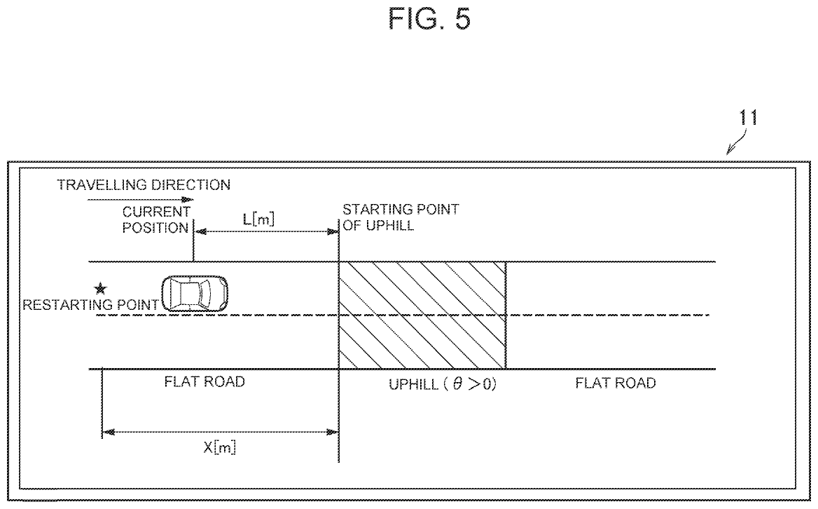

Consequently, the restarting point is set X meter(s) short of the starting point of the uphill. For example, the driver is informed of the restarting point thus determined by indicating the illustration shown in FIG. 5 in the human-machine interface 11 so that the driver is urged to return the vehicle Ve to the restarting point.

After the vehicle Ve is returned to the restarting point, the driver is instructed how to manipulate the accelerator pedal 4 to establish the required vehicle speed Vt before reaching the starting point of the uphill.

Thus, the control system according to the exemplary embodiment of the present disclosure is configured to determine whether the vehicle Ve can be accelerated to reach the top of the uphill before reaching the starting point of the uphill. In the case that the vehicle Ve can be accelerated to reach the top of the uphill, the driver is instructed to depress the accelerator pedal 4 in such a manner that it is possible to accelerate the vehicle Ve to climb uphill all the way to the top. Otherwise, the driving force to propel the vehicle Ve is controlled autonomously in such a manner that it is possible to accelerate the vehicle Ve to climb uphill all the way to the top. According to the exemplary embodiment of the present disclosure, therefore, the vehicle Ve is allowed to reach the top of the uphill without stopping on the way to the top.

By contrast, in the case that the vehicle Ve cannot be accelerated on the uphill at the current vehicle speed Vo, the required vehicle speed Vt to reach the top of the hill is calculated. If the current vehicle speed Vo is equal to or higher than the required vehicle speed Vt, the driver is instructed how to manipulate the accelerator pedal 4 to maintain the speed of the vehicle Ve to the required vehicle speed Vt or higher before reaching the starting point of the uphill. According to the exemplary embodiment of the present disclosure, therefore, the vehicle Ve is allowed to reach the top of the uphill without stopping on the way to the top.

By contrast, if the current vehicle speed Vo is lower than the required vehicle speed Vt, the required period of time t to increase the speed of the vehicle Ve to the required vehicle speed Vt is calculated. In this case, if the speed of the vehicle Ve can be increased to the required vehicle speed Vt within the required period of time t, the driver is instructed to operate the accelerator pedal 4 in such a manner as to increase the speed of the vehicle Ve to the required vehicle speed Vt. Otherwise, the driving force is controlled autonomously in such a manner as to increase the speed of the vehicle Ve to the required vehicle speed Vt. According to the exemplary embodiment of the present disclosure, therefore, the vehicle Ve is allowed to reach the top of the uphill without stopping on the way to the top.

By contrast, if the speed of the vehicle Ve cannot be increased to the required vehicle speed Vt within the required period of time t, the driver is instructed to return the vehicle Ve to the restarting point where it is possible to ensure a distance necessary to increase the speed of the vehicle Ve to the required vehicle speed Vt before the vehicle Ve reaches the starting point of the uphill. According to the exemplary embodiment of the present disclosure, therefore, the vehicle Ve is allowed to reach the top of the uphill without stopping on the way to the top.

Thus, according to the exemplary embodiment of the present disclosure, the driver is instructed how to manipulate the accelerator pedal 4 to climb uphill all the way to top before reaching the starting point of the uphill in every situation. According to the exemplary embodiment of the present disclosure, therefore, the vehicle Ve is allowed to reach the top of the uphill without stopping on the way to the top in every situation.

Although the above exemplary embodiments of the present disclosure have been described, it will be understood by those skilled in the art that the present disclosure should not be limited to the described exemplary embodiments, and various changes and modifications can be made within the scope of the present disclosure. For example, the routine shown in FIG. 2 may also be executed by the external server or terminal instead of the ECU 7. In this case, not only newly manufactured vehicles but also vehicles already in use may be controlled to climb uphill certainly in every situation.

In addition, in the routine shown in FIG. 2, the required vehicle speed Vt is calculated in the case that the vehicle Ve cannot be accelerated on the uphill. However, such determination may be omitted, and steps S3, S5, and S6 may be executed based on a determination result at step S4. Further, the routine shown in FIG. 2 may also be executed during propulsion on a paved road in which a running resistance is relatively low.

What is claimed is:

1. A driving force control system for a vehicle that detects a road surface condition to control a driving force to allow the vehicle to climb uphill, comprising:
a controller that controls the driving force,
wherein the controller is configured to
calculate a slip ratio of a road surface on which the vehicle travels, a driving force with respect to the slip ratio, and a running resistance including a grade resistance of the road surface, before the vehicle reaches a starting point of an upcoming uphill,
determine whether the vehicle can climb the uphill all the way to the top based on the driving force and the running resistance, and
execute a driver assisting control to instruct a driver to manipulate an accelerator in such a manner as to optimize the slip ratio to establish a predetermined driving force, if the vehicle can climb uphill all the way to the top.

2. The driving force control system for the vehicle as claimed in claim 1, wherein the controller is further configured to
calculate a required speed of the vehicle to climb the uphill all the way to the top from the starting point of the uphill, if the vehicle cannot climb the uphill all the way to the top,
determine whether a speed of the vehicle at the starting point of the uphill is higher than the required speed, and
execute the driver assisting control to instruct the driver to manipulate the accelerator in such a manner as to optimize the slip ratio to establish the predetermined driving force, if the speed of the vehicle at the starting point of the uphill is higher than the required speed.

3. The driving force control system for the vehicle as claimed in claim 2, wherein the controller is further configured to
determine whether the vehicle can be accelerated to increase the speed of the vehicle to the required speed or higher at the starting point of the uphill, if the speed of the vehicle at the starting point of the uphill is lower than the required speed, and
execute the driver assisting control to instruct the driver to manipulate the accelerator in such a manner as to optimize the slip ratio to establish the predetermined driving force, if the vehicle can be accelerated to increase the speed of the vehicle to the required speed or higher at the starting point of the uphill.

4. The driving force control system for the vehicle as claimed in claim 3, wherein the controller is further configured to set the required speed to a value at which a kinetic energy of the vehicle comes into balance with a potential energy of the vehicle at the top of the uphill.

5. The driving force control system for the vehicle as claimed in claim 3, wherein the controller is further configured to determine whether the vehicle can be accelerated to increase the speed of the vehicle to the required speed based on a current speed of the vehicle, the required speed, an acceleration of the vehicle, a required period of time to increase the speed of the vehicle from the current speed to the required speed, and a distance from a current location of the vehicle to the starting point of the uphill.

6. The driving force control system for the vehicle as claimed in claim 3, wherein the controller is further configured to
calculate a restarting point where it is possible to ensure a distance necessary to increase the speed of the vehicle to the required speed before the vehicle reaches the starting point of the uphill, if the vehicle cannot be accelerated to increase the speed of the vehicle to the required speed, and
instruct the driver to return the vehicle to the restarting point.

7. The driving force control system for the vehicle as claimed in claim 1, wherein an operating mode of the vehicle includes an autonomous mode in which the driving force is controlled autonomously by the controller without requiring a manual operation.

8. The driving force control system for the vehicle as claimed in claim 1, wherein the accelerator includes an accelerator pedal, and
the controller is further configured to instruct the driver to depress and return the accelerator pedal.

9. A driving force control system for a vehicle that detects a road surface condition including a slip ratio to control a driving force to allow the vehicle to climb an uphill, comprising:
a controller that controls the driving force,
wherein the controller is configured to
calculate a required speed of the vehicle to climb the uphill all the way to the top from a starting point of the uphill,
determine whether a speed of the vehicle at the starting point of the uphill is higher than the required speed, and
execute a driver assisting control to instruct a driver to manipulate an accelerator in such a manner as to optimize the slip ratio to establish a predetermined driving force, if the speed of the vehicle at the starting point of the uphill is higher than the required speed.

10. The drive force control system for the vehicle as claimed in claim 9, wherein the controller is further configured to
determine whether the vehicle can be accelerated to increase the speed of the vehicle to the required speed or higher at the starting point of the uphill, if the speed of the vehicle at the starting point of the uphill is lower than the required speed, and
execute the driver assisting control to instruct the driver to manipulate the accelerator in such a manner as to optimize the slip ratio to establish the predetermined driving force, if the vehicle can be accelerated to increase the speed of the vehicle to the required speed or higher at the starting point of the uphill.

11. The driving force control system for the vehicle as claimed in claim 10, wherein the controller is further configured to set the required speed to a value at which a kinetic energy of the vehicle comes into balance with a potential energy of the vehicle at the top of the uphill.

12. The driving force control system for the vehicle as claimed in claim 11, wherein the controller is further configured to determine whether the vehicle can be accelerated to increase the speed of the vehicle to the required speed based on a current speed of the vehicle, the required speed, an acceleration of the vehicle, a required period of time to increase the speed of the vehicle from the current speed to the required speed, and a distance from a current location of the vehicle to the starting point of the uphill.

13. The driving force control system for the vehicle as claimed in claim 10, wherein the controller is further configured to
calculate a restarting point where it is possible to ensure a distance necessary to increase the speed of the vehicle to the required speed before the vehicle reaches the starting point of the uphill, if the vehicle cannot be accelerated to increase the speed of the vehicle to the required speed, and
instruct the driver to return the vehicle to the restarting point.
